(19) United States
(12) Patent Application Publication
(10) Pub. No.: US 2026/0050452 A1
(43) Pub. Date: Feb. 19, 2026

(54) SYSTEMS AND METHODS FOR MANAGING FRONTEND APPLICATION DEPENDENCIES USING DYNAMIC LOADING

(71) Applicant: Acronis International GmbH, Schaffhausen (CH)

(72) Inventors: German BARTENEV, Singapore (SG); Xiaowen TANG, Singapore (SG); Serg BELL, Costa Del Sol (SG); Stanislav PROTASOV, Singapore (SG)

(21) Appl. No.: 18/805,705

(22) Filed: Aug. 15, 2024

(51) Int. Cl. G06F 9/445

(52) U.S. Cl. CPC G06F 9/44521

(57) ABSTRACT

Disclosed herein are systems and method for managing frontend application dependencies. In one aspect, a method includes: in response to determining that a first frontend application requests functionality that is not present in a first interface library of the first frontend application, activating a frontend loader application that loads an original library implementation with code for performing the functionality; injecting, via the frontend loader application, the original library implementation into a window object that functions as a specialized storage area; accessing, via the first frontend application, the original library implementation from the window object; and executing the functionality via the first frontend application using the original library implementation.

### FIELD OF TECHNOLOGY

The present disclosure relates to the field of software development, and, more specifically, to systems and methods for managing frontend application dependencies using dynamic loading.

### BACKGROUND

Frontend application development involves crafting user interfaces that are intuitive and responsive, ensuring seamless interaction between users and digital products. Developers use languages such as HTML, CSS, and JavaScript to design and implement these interfaces, focusing on usability and visual appeal. There are also means to run multiple frontend applications in a web browser tab simultaneously. There are various technical issues and inefficiencies in frontend development, including excessive bundle size, inefficient static loading, version change handling, and cross dependency management between libraries.

In terms of bundle size, standard practice in frontend development involves bundling all required libraries together at build time. This typically leads to large and unwieldy bundles, adversely affecting application performance, particularly for users on limited bandwidth or slower networks.

In terms of inefficient static loading, traditional methods load all dependencies upfront, regardless of immediate need. This often results in slower initial application load times and inefficient use of resources.

In terms of the difficulty in handling version changes, conventional systems struggle with dynamically adapting to library updates and version changes. This often requires updating the same library across multiple components, leading to increased development time, potential application downtime, and degraded user experience.

In terms of cross dependencies between libraries, intricate dependency chains can lead to challenges in both maintaining and updating the libraries. Such complexity may cause duplicated or conflicting instances of the same shared library to be loaded, complicating dependency resolution. Furthermore, updates in one library may require cascading changes in others, leading to increased development effort and potential risks of application downtime.

### SUMMARY

In order to address the shortcomings described in the background, the present disclosure describes an approach employing specialized loader frontend applications, each designed for loading specific shared libraries or inseparable library groups into a global window object.

During runtime, if a frontend application “Application ABC” needs a certain library (e.g., requires its implementation), the frontend application checks the global window object first. If not found, a dedicated loader application, functioning as a separately-hosted frontend application for loading libraries, is requested and launched. The loader application then efficiently injects the required library into the global window object and then terminates to conserve resources.

Accordingly, developers reference only library interfaces, ensuring on-demand loading and reduced bundle sizes. All components, regardless of their level in the browser tab, may access these libraries from the global window object. If a library is absent, its respective loader activates once, making the library available for all subsequent uses within the tab.

In one exemplary aspect, the techniques described herein relate to a method for managing frontend application dependencies, the method including: in response to determining that a first frontend application requests functionality that is not present in a first interface library of the first frontend application, activating a frontend loader application that loads an original library implementation with code for performing the functionality; placing, via the frontend loader application, the original library implementation into a window object that functions as a specialized storage area; accessing, via the first frontend application, the original library implementation from the window object; and executing the functionality via the first frontend application using the at least one portion of the original library implementation.

In some aspects, the techniques described herein relate to a method, further including: terminating the frontend loader application subsequent to placing the original library implementation into the window object.

In some aspects, the techniques described herein relate to a method, further including: detecting a new library version of the original library implementation; and updating a version of the original library implementation to the new library version solely in the frontend loader application and not in any other frontend application.

In some aspects, the techniques described herein relate to a method, wherein the first frontend application is included in a plurality of frontend applications in a tab frame, further including: receiving a request for the functionality from a second frontend application of the plurality of frontend applications; accessing, via the second frontend application, the original library implementation from the window object; and executing the functionality via the second frontend application using the original library implementation.

In some aspects, the techniques described herein relate to a method, wherein the plurality of frontend applications are part of a large frontend application, and wherein the first frontend application and the second frontend application share a common dependency to the original library implementation via the interface library.

In some aspects, the techniques described herein relate to a method, wherein the frontend loader application is configured to coordinate any interdependencies between a dedicated library of the frontend loader application and other libraries of the plurality of frontend applications via their interface libraries.

In some aspects, the techniques described herein relate to a method, wherein placing, via the frontend loader application, the original library implementation into the window object is in response to determining that the window object does not have the original library implementation.

It should be noted that the methods described above may be implemented in a system comprising a hardware processor. Alternatively, the methods may be implemented using computer executable instructions of a non-transitory computer readable medium.

In some aspects, the techniques described herein relate to a system for managing frontend application dependencies, including: at least one memory; at least one hardware processor coupled with the at least one memory and configured, individually or in combination, to: in response to determining that a first frontend application requests functionality that is not present in a first interface library of the first frontend application, activate a frontend loader application that loads an original library implementation with code for performing the functionality; place, via the frontend loader application, the original library implementation into a window object that functions as a specialized storage area; access, via the first frontend application, the original library implementation from the window object; and execute the functionality via the first frontend application using the original library implementation.

In some aspects, the techniques described herein relate to a non-transitory computer readable medium storing thereon computer executable instructions for managing frontend application dependencies, including instructions for: in response to determining that a first frontend application requests functionality that is not present in a first interface library of the first frontend application, activating a frontend loader application that loads an original library implementation with code for performing the functionality; placing, via the frontend loader application, the original library implementation into a window object that functions as a specialized storage area; accessing, via the first frontend application, the original library implementation from the window object; and executing the functionality via the first frontend application using the original library implementation.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for managing frontend application dependencies using dynamic loading.

FIG. 2 is a diagram illustrating how the original library implementation is loaded.

FIG. 3 illustrates a flow diagram of a method for loading the original library implementation.

FIG. 4 is a flow diagram illustrating a method for managing frontend application dependencies using dynamic loading.

FIG. 5 presents an example of a general-purpose computer system on which aspects of the present disclosure can be implemented.

### DETAILED DESCRIPTION

Exemplary aspects are described herein in the context of a system, method, and computer program product for managing frontend application dependencies using dynamic loading. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

Efficient library management is a critical yet challenging aspect of modern frontend development. Traditional approaches, ranging from monolithic bundling to individual library management, often result in increased load times, redundant data transfer, and complex version and dependency conflicts.

In a scenario where multiple frontend applications within a single console or large frontend application share a common dependency (e.g., D3.js, which may be used for data visualization in some but not all frontend applications), there are a few existing approaches to manage the situation. Traditionally, dependencies are bundled into a single, large file that is loaded at the application's start. While simple, this causes long load times and poor resource utilization due to the size of the monolithic bundle.

Tools and bundlers create a shared bundle for common dependencies, which is cached by the browser. However, this still necessitates an initial load and a complete reload for any updates, leading to inefficiencies, especially when only small changes are needed. Modern tools such as Webpack™ resolve and load dependencies at runtime, allowing applications to load only what they need. But this does not effectively address the issue of dependency management across nested applications, which can result in duplicated libraries and version conflicts.

The present disclosure introduces a paradigm shift with specialized loader applications. These loaders, which are separately hosted frontend applications, are each tailored to manage specific libraries or closely linked library groups. This approach directly addresses the inefficiencies of existing methods by ensuring libraries are loaded only when needed, significantly reducing unnecessary pre-loading and resource consumption. “Separately hosted” means that each loader application operates independently and is hosted as a distinct service or application. Unlike traditional methods where all libraries are bundled together within a single frontend application, these loader applications are standalone entities. They are responsible for loading specific libraries or closely linked library groups and can be deployed and managed independently from the main frontend application. This separation allows for greater flexibility and efficient management of dependencies, as each loader can be updated or modified without affecting the main application or other loaders.

The disclosed systems and methods are beneficial in environments with multiple frontend applications or complex dependency structures by simplifying the library management process and reducing the overall footprint of applications. As a result, this solution not only enhances performance but also improves the maintainability and scalability of frontend ecosystems. This is particularly vital as applications grow in complexity and size, requiring more agile and responsive management of resources. Ultimately the approach of the present disclosure shows a significant advancement in frontend application development, catering to the growing complexity and size of modern web applications.

It should be noted that the dynamic loading system of the present disclosure differs from caching in many ways, including in its proactive management and on-demand loading capabilities. Firstly, the system dynamically loads and injects libraries only when they are explicitly requested by a frontend application, ensuring resources are utilized efficiently by avoiding the pre-loading of unused libraries. Once a library is loaded and injected, it is stored in the window object, acting as a cache for subsequent requests, thus combining dynamic loading with the benefits of caching. The dynamic loading system also excels in version management, ensuring that the appropriate version of a library is loaded as needed to maintain compatibility, whereas traditional caching may not handle versioning as effectively, potentially leading to conflicts. Unlike traditional caching, which typically stores entire libraries or data sets, the dynamic loading system focuses on loading libraries based on actual runtime requirements, thereby optimizing resource usage and reducing the likelihood of storing unnecessary data. This method provides a flexible and efficient approach to managing frontend dependencies, allowing new libraries to be added and managed without extensive pre-configuration or code changes.

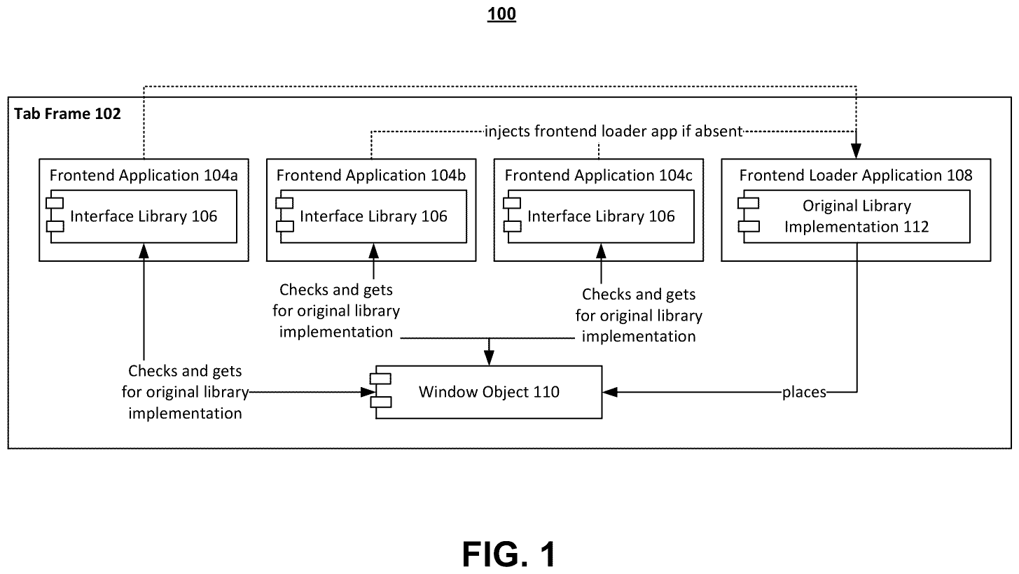

FIG. 1 is a block diagram illustrating system 100 for managing frontend application dependencies using dynamic loading. System 100 includes tab frame 102, which further includes frontend applications 104a, 104b, and 104c. Tab frame 102 refers to the environment or container within a web browser tab where multiple frontend applications can coexist and interact. For example, tab frame 102 may be a single browser tab that hosts various independent frontend applications, each potentially running different functionalities or parts of a larger application. Tab frame 102 manages these applications and facilitates their communication and resource sharing. Although only three frontend applications are shown, a person skilled in the art will appreciate that any number of frontend applications may exist in tab frame 102. Each of frontend applications 104a, 104b, and 104c further includes interface library 106. An interface library is a tool in software development that simplifies the interaction between different software components or between software and hardware. An interface library provides a structured set of functions or methods that abstract away the complexities of directly accessing and manipulating underlying systems. This abstraction allows developers to focus on implementing the core logic of their applications without needing to delve deeply into the technical details of every component they interact with. Here, the same library is being used across different frontend applications via the interface library. Using dynamic loading, the library implementation is separately packaged and injected via the loader application only when needed.

An example of the functionality of frontend applications 104a, 104b, and 104c could be within a web-based dashboard for a managed service provider (MSP). Here are three potential frontend applications within the tab frame. Application 104a may be a dashboard displaying real-time analytics and numerical data, such as total storage usage, backup frequency, and error rates for various managed servers. Application 104b may be an application with visualization interface that presents processed data in graphical forms like charts and graphs, providing visual insights into trends and patterns in the server performance data. Application 104c may be an incident management system allowing users to log, track, and resolve incidents, including monitoring incident statuses and assigning tasks to support staff. These applications share common libraries, but operate independently within the same tab frame.

An interface library in this context ensures consistency and efficiency by standardizing the way frontend applications interact with shared functionalities. For example, a common interface library might include methods for handling data processing, data visualization, and UI rendering, allowing different frontend applications to leverage these shared capabilities without duplicating code. This approach not only reduces development effort but also ensures that updates and improvements to the library benefit all dependent applications simultaneously.

Consider a scenario where multiple frontend applications (e.g., 104a, 104b, etc.) within tab frame 102 need to use a shared library for processing data (e.g., interface library 106). Loader application 108 is responsible for loading the implementation of the data processing interface library. When frontend application 104a calls process data function of interface library 106, it triggers the execution of the function, which checks for the original library implementation. If the data processing library is missing, loader application 108 loads the original library implementation 112, and places it into the window object. As a result, frontend application 104a is then able to get the original library implementation of the interface library 106 from the window object, and process data function continues its execution. Now the library implementation 112 is downloaded and stored. When frontend application 104b calls the process data function of interface library 106, it finds the original library implementation 112 already available and proceeds without needing to load any additional libraries.

When any of the frontend applications (104a, 104b, or 104c) calls the interface library's function (e.g., interface library 106), it checks and finds that the original library implementation of interface library 106 is missing. The system then injects frontend loader application 108 to load and inject the original library implementation of interface library 106. Accordingly, when requested, tab frame 102 further includes frontend loader application 108, which includes original library implementation 112. The original library implementation typically includes the full set of code and functionalities that make up the core logic of a software component or system. It encompasses not only the interface but also the internal workings, algorithms, and data structures that fulfill its intended purpose. Developers working with the original library implementation might need to understand these internals to fully leverage and customize its capabilities.

It should be noted that an interface library operates at a high level of abstraction that shields developers from low-level details. In contrast, the original library implementation operates at a lower level of abstraction, exposing the detailed workings of the library. Developers working with the original implementation have direct access to all functionalities and can potentially modify or extend the library's capabilities by understanding and manipulating its internal structure.

Lastly, system 100 includes window object 110, which functions as a special storage area for dynamically loaded library implementations, within tab frame 102.

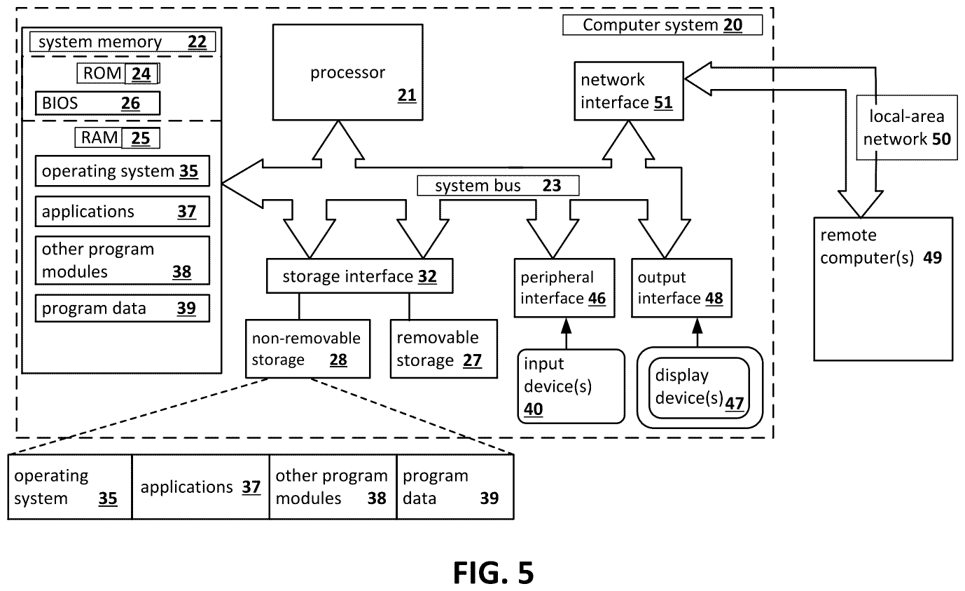

System 100 may be executed on a computer system (described in FIG. 5). System 100 runs a dynamic loading mechanism, whose core feature is its two-fold dynamic nature. Frontend loader application 108 is dedicated for loading its respective library or group of un-separatable libraries. The loader applications are specifically downloaded and launched only once and on-demand. More specifically, implementation of the shared libraries are downloaded and put in window object 110 on-demand by frontend loader application 108. This approach maximizes resource utilization efficiency and overcomes limitations of traditional bundling methods.

As mentioned before, window object 110 functions as a specialized storage area, providing a container for dynamically loaded libraries by frontend loader application 108. This design enhances the flexibility and efficiency of system 100, facilitating easy access and management of shared resources. It should be noted that tab frame 102 may include any number of loader applications despite only one being shown in FIG. 1. Multiple loader applications offer several advantages such as modularity, reduced resource usage, fault isolation, and scalability. In terms of modularity, each loader can manage a specific set of libraries, making it easier to update or replace individual libraries without impacting others. In terms of reduced resource usage, by only loading the libraries needed by specific parts of the application, resource usage is optimized, leading to better performance. In terms of fault isolation, if one loader application encounters an issue, it does not affect the other loaders, enhancing the overall stability of the system. In terms of scalability, the system can scale more efficiently by deploying additional loaders as needed, each handling different libraries or library groups.

The architecture ensures that the shared libraries' versions within the unified environment are well managed in a central place. Updating any library's version is only needed in frontend loader application 108, instead of making changes in all usage places. The architecture further optimizes dependency management, preventing duplication of dependencies and reducing overall bundle size. This not only enhances performance, but also contributes to more efficient deployment and maintenance.

To address the complexities of cross-dependencies, each frontend loader application (e.g., application 108) manages not only its dedicated library but also coordinates any interdependencies with other libraries by referring to their interfaces. This ensures efficient usage of shared dependencies across different parts of the application, enables seamless compatibility, and prevents version conflicts. Considering a scenario where a frontend application (e.g., application 104a) requests to execute a process data function from the data processing interface library 106. The frontend loader application (e.g., application 108) loads and places the implementation of interface library 106 (e.g., original library implementation 112) into the window object, in response to determining that the window object does not have the original library implementation. Subsequently, a second frontend application (e.g. application 104b) retrieves this implementation from the window object, and requests to execute a “generate chart” function, which depends on visualization interface library 208 (not shown in FIG. 1) for rendering charts. Since the implementation of the interface library 208 is not yet loaded, another frontend loader application (not shown in FIG. 1) is triggered to load and place the implementation of interface library 208 into the window object. This ensures that the generate chart function can now execute successfully using the newly available visualization interface library 208. This method optimizes resource usage by loading libraries only when they are needed and ensures that frontend applications can seamlessly access and utilize the necessary libraries without redundancy

Continuing with the previous example, suppose there is a minor version update for interface library 106. The respective frontend loader application (application 108) updates it to the new version, and when frontend applications request the library, they automatically access the updated versions from the window object, without any additional development cost or downtime. This ensures that all frontend applications use the correct and latest library versions, preventing conflicts and ensuring seamless operation. By centrally managing library versions through dedicated loader applications, the system ensures efficient and conflict-free usage of shared libraries.

By combining these architectural elements, system 100 not only addresses challenges specific to the ecosystem, but also provides a versatile and scalable framework for large-scale frontend development in various contexts.

This technology is beneficial for all frontend products, including working frontend products for managed service providers (MSPs), single consoles, and internal libraries. For example, the user interface (UI) of admin and product control panels for MSPs features a blend of static and dynamically injected extensions as components, containing frontend applications, which can be created using in-house technology equipped with runtime configurations. With the dynamic loader application approach, system 100 facilitates efficient loading of necessary libraries and components on demand, enhancing UI responsiveness and scalability. This leads to optimized resource usage, faster load times, and a more adaptable platform for MSPs to tailor their control panels according to specific needs.

A single console, which may be designed as a centralized hub, unifies all hosted frontend applications and their child applications into one comprehensive portal. This console streamlines application management for MSPs, offering integrated runtime configurations. The dynamic loader application approach here plays a crucial role in efficiently managing library dependencies, ensuring that each application within the console loads only the necessary resources of the latest possible version, thereby improving performance, reducing load times, and enhancing the user experience within this consolidated environment.

Furthermore, internal libraries that are utilized across various frontend applications, sometimes need to reference other internal libraries. The architecture of system 100 facilitates these interactions by allowing libraries to reference others via interfaces only, and further load and use implementation of these shared libraries efficiently. This approach keeps the libraries lean and user-friendly, reducing the overall complexity and improving maintainability within the frontend ecosystem.

In summary, the systems and methods of the present disclosure offer several advantages. The “loader” frontend application is activated only when a frontend application requests a library that is not present, optimizing resource utilization by loading libraries only as needed. Once the “loader” application loads a library, it ensures that any subsequent requests for that library are served from the same instance, eliminating unnecessary downloads and reducing network traffic. The system centralizes the management of library versions, simplifying updates, and ensuring consistency across all applications, which is particularly beneficial in environments with nested applications.

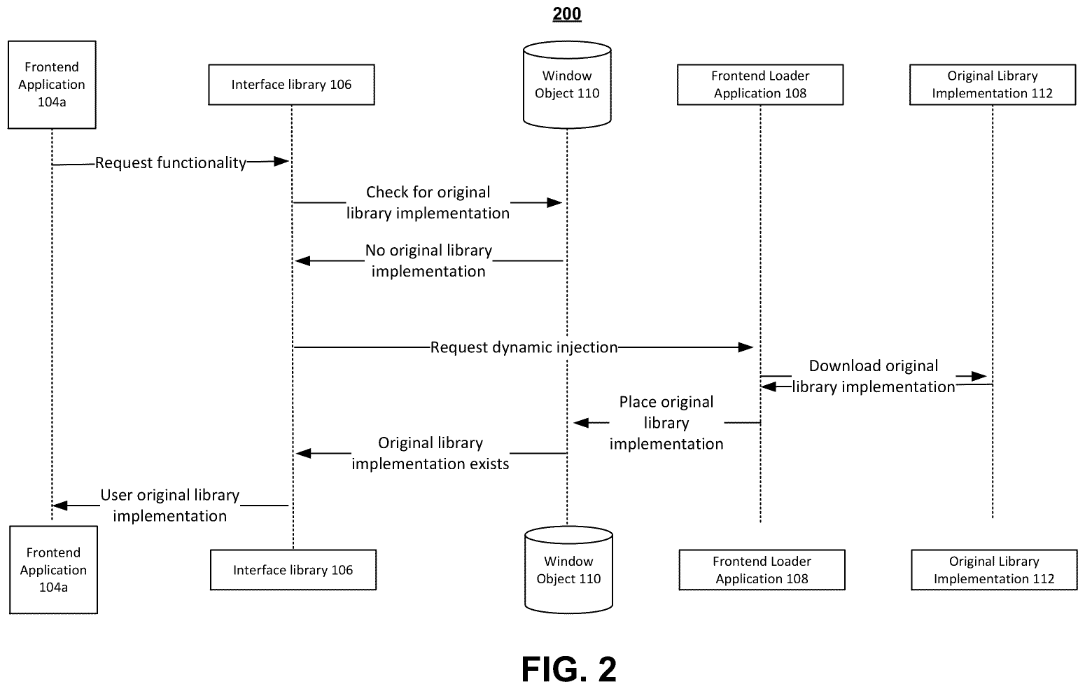

FIG. 2 is a diagram 200 illustrating how the original library implementation is loaded. Diagram 200 focuses on a single frontend application (104a) from FIG. 1; nevertheless, it should be noted that all frontend applications shown in FIG. 1 would operate in the same manner. Firstly frontend application 104a requests some functionality from interface library 106. Interface library 106 checks the original library implementation in window object 110. If window object 110 determines that the library for performing the functionality is not found, interface library 106 is informed. Interface library 106 then requests frontend loader application 108 to activate and inject the required library implementation. Accordingly, frontend loader application 108 retrieves the original library implementation and places the implementation into window object 110. From there, window object 110 provides the implementation to interface library 106, which helps frontend application 104a perform the requested functionality. The library retrieved and injected by the frontend loader application 108 is specifically for the functionality requested by the frontend application 104a. This ensures that only the necessary code and resources are loaded, reducing overhead and improving efficiency. The library contains the exact implementation required to perform the functionality, avoiding the need to load a larger, more general library that includes unnecessary components.

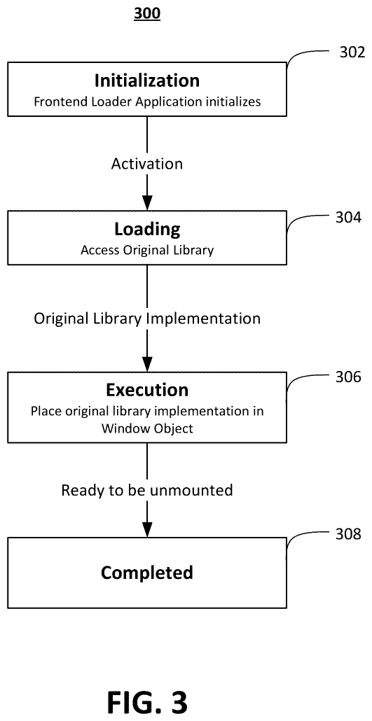

FIG. 3 illustrates a flow diagram of method 300 for loading the original library implementation. At 302, frontend loader application 108 is initialized. After activating, frontend loader application 108 retrieves the original library implementation. At 306, frontend loader application places the original library implementation into window object 110. Frontend loader application 108 is then ready to be unmounted.

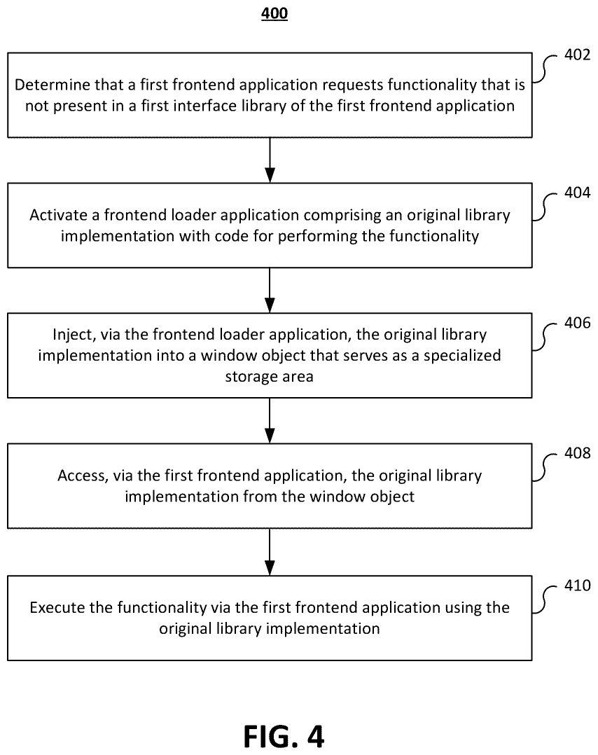

FIG. 4 is a flow diagram illustrating method 400 for managing frontend application dependencies using dynamic loading. At 402, a first frontend application (e.g., application 104a) determines that requests functionality that is not present in the interface library (e.g., interface library 106) of the first frontend application.

At 404, frontend loader application (e.g., application 108) activates. The frontend loader application includes an original library implementation (e.g., implementation 112) with code for performing the functionality.

At 406, frontend loader application injects the original library implementation into a window object (e.g., object 110) that functions as a specialized storage area within the frontend application. In some aspects, the frontend loader application injects the original library implementation in the window object in response to determining that the window object does not have the original library implementation.

At 408, the first frontend application accesses the original library implementation from the window object.

At 410, the first frontend application executes the functionality using the original library implementation.

In some aspects, subsequent to injecting the original library implementation in the window object, the frontend loader application terminates.

In some aspects, frontend loader application detects a new library version of the original library implementation. Frontend loader application then updates a version of the original library implementation to the new library version. This update is performed solely in the frontend loader application and not in any other frontend application (e.g., frontend application 104a).

In some aspects, the first frontend application is comprised in a plurality of frontend applications in a tab frame (e.g., tab frame 102). A second frontend application (e.g., frontend application 104b) of the plurality of frontend applications may request some functionality from the first interface library, which requests functionality from a second interface library and determines that the second interface library (not shown in FIG. 1) does not have code to execute the functionality. The second frontend application may then request a different frontend loader application (e.g., not shown in FIG. 1) to download and place implementation of the second interface library to window object 110. The second frontend application may then access the original library implementation of the second interface library from the window object, and execute the functionality accordingly.

In some aspects, the plurality of frontend applications are part of a large frontend application, and the first frontend application and the second frontend application share a common dependency on the original library implementation. The frontend loader application is configured to coordinate any interdependencies between its dedicated library and other libraries of the plurality of frontend applications.

FIG. 5 is a block diagram illustrating a computer system 20 on which aspects of systems and methods for managing frontend application dependencies using dynamic loading may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-4 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for managing frontend application dependencies, the method comprising:
in response to determining that a first frontend application requests functionality not present in a first interface library of the first frontend application, activating a frontend loader application comprising an original library implementation with code for performing the functionality;
injecting, via the frontend loader application, the original library implementation into a window object that functions as a specialized storage area;
downloading, via the first frontend application, the original library implementation from the window object; and
executing the functionality via the first frontend application using the original library implementation.

2. The method of claim 1, further comprising:
terminating the frontend loader application subsequent to injecting the original library implementation in the window object.

3. The method of claim 1, further comprising:
detecting a new library version of the original library implementation; and
updating a version of the original library implementation to the new library version solely in the frontend loader application and not in any other frontend application.

4. The method of claim 1, wherein the first frontend application is comprised in a plurality of frontend applications in a tab frame, further comprising:
receiving a request for the functionality from a second frontend application of the plurality of frontend applications;
accessing, via the second frontend application, the original library implementation from the window object; and
executing the functionality via the second frontend application using the original library implementation.

5. The method of claim 4, wherein the plurality of frontend applications are part of a large frontend application, and wherein the first frontend application and the second frontend application share a common dependency to the original library implementation.

6. The method of claim 4, wherein the frontend loader application is configured to coordinate any interdependencies between a dedicated library of the frontend loader application and other libraries of the plurality of frontend applications via interface libraries.

7. The method of claim 1, wherein injecting, via the frontend loader application, the original library implementation into the window object is in response to determining that the window object does not have the original library implementation.

8. A system for managing frontend application dependencies, comprising:
at least one memory;
at least one hardware processor coupled with the at least one memory and configured, individually or in combination, to:
in response to determining that a first frontend application requests functionality not present in a first interface library of the first frontend application, activate a frontend loader application comprising an original library implementation with code for performing the functionality;
inject, via the frontend loader application, the original library implementation into a window object that functions as a specialized storage area;
access, via the first frontend application, the original library implementation from the window object; and
execute the functionality via the first frontend application using the original library implementation.

9. The system of claim 8, wherein the at least one hardware processor is further configured to:
terminate the frontend loader application subsequent to injecting the original library implementation in the window object.

10. The system of claim 8, wherein the at least one hardware processor is further configured to:
detect a new library version of the original library implementation; and
update a version of the original library implementation to the new library version solely in the frontend loader application and not in any other frontend application.

11. The system of claim 8, wherein the first frontend application is comprised in a plurality of frontend applications in a tab frame, wherein the at least one hardware processor is further configured to:
receive a request for the functionality from a second frontend application of the plurality of frontend applications;
access, via the second frontend application, the original library implementation from the window object; and
execute the functionality via the second frontend application using the original library implementation.

12. The system of claim 11, wherein the plurality of frontend applications are part of a large frontend application, and wherein the first frontend application and the second frontend application share a common dependency to the original library implementation.

13. The system of claim 11, wherein the frontend loader application is configured to coordinate any interdependencies between a dedicated library of the frontend loader application and other libraries of the plurality of frontend applications via interface libraries.

14. The system of claim 8, wherein the at least one hardware processor is further configured to inject, via the frontend loader application, the original library implementation into the window object in response to determining that the window object does not have the original library implementation.

15. A non-transitory computer readable medium storing thereon computer executable instructions for managing frontend application dependencies, including instructions for:
in response to determining that a first frontend application requests functionality not present in a first interface library of the first frontend application, activating a frontend loader application comprising an original library implementation with code for performing the functionality;
injecting, via the frontend loader application, the original library implementation into a window object that functions as a specialized storage area;
accessing, via the first frontend application, the original library implementation from the window object; and
executing the functionality via the first frontend application using the original library implementation.

16. The non-transitory computer readable medium of claim 15, further comprising instructions for:
terminating the frontend loader application subsequent to injecting the original library implementation in the window object.

17. The non-transitory computer readable medium of claim 15, further comprising instructions for:
detecting a new library version of the original library implementation; and
updating a version of the original library implementation to the new library version solely in the frontend loader application and not in any other frontend application.

18. The non-transitory computer readable medium of claim 15, wherein the first frontend application is comprised in a plurality of frontend applications in a tab frame, further comprising instructions for:
receiving a request for the functionality from a second frontend application of the plurality of frontend applications;
accessing, via the second frontend application, the original library implementation from the window object; and
executing the functionality via the second frontend application using the original library implementation.

19. The non-transitory computer readable medium of claim 18, wherein the plurality of frontend applications are part of a large frontend application, and wherein the first frontend application and the second frontend application share a common dependency to the original library implementation.

20. The non-transitory computer readable medium of claim 18, wherein the frontend loader application is configured to coordinate any interdependencies between a dedicated library of the frontend loader application and other libraries of the plurality of frontend applications via interface libraries.
